(19) United States
(12) Patent Application Publication
(10) Pub. No.: US 2006/0226391 A1
(43) Pub. Date: Oct. 12, 2006

(54) Water valve with expanding fittings

(76) Inventor: Kenneth C. Kramer, Branchburg, NJ (US)

Correspondence Address: LITMAN LAW OFFICES, LTD, PO BOX 15035, CRYSTAL CITY STATION, ARLINGTON, VA, 22215, US

(21) Appl. No.: 11/102,826

(22) Filed: Apr. 11, 2005

(51) Int. Cl. F16K 3/00

(52) U.S. Cl. 251/326

(57) ABSTRACT

A water valve with expanding fittings includes a valve body having an inlet pipe and an outlet pipe extending outward from the valve body. The inlet pipe is formed from an annular wall having an outwardly extending lip about an end of the pipe. The wall of the inlet pipe has a passage defined therein extending from adjacent the valve body and has a discharge opening adjacent the lip. The water valve includes a sleeve with an attached pipe flange at a first end and an inwardly extending lip at an opposing second end. The inlet pipe lip is slidably disposed within the sleeve, and the sleeve lip encircles the inlet pipe between the inlet pipe lip and the valve body to prevent separation of the sleeve from the inlet pipe. The sleeve travels with a limited range along the outward surface of the lip of the inlet pipe.

### BACKGROUND OF THE INVENTION

1. Field of the Invention

The present invention relates to valves, and particularly to a water valve with expanding fittings that has hydraulically operated flanges that extend in order to fit a valve into any type of piping system, e.g., shipping applications, marine applications, building applications, vehicle applications, aviation applications, etc.

2. Description of the Related Art

Virtually every commercial, industrial, residential site, as well as every marine, aviation, train, vehicular application requires piping for the conveyance of liquids or gases. The most common piping application is for water. Whether it is the water pipes in a private home, high-pressure steam lines in a power plant, saltwater cooling lines aboard a ship, or the water mains in a treatment plant, water pipes are very common.

Some piping installations, such as those used in industrial or marine settings, can be very complicated. Liquids and gases are conveyed at a large variety of temperatures and pressures through an array of different kinds of pipes made from such diverse materials as cast and wrought iron, steel, stainless steel, copper, brass, lead, non-ferrous and ferrous alloys, and plastic materials. Adding to this complexity is the fact that many piping systems must be installed in cramped or confined quarters, leaving little room to perform maintenance or repair on the piping system.

A crucial component of any piping system is the valves in the system. A valve is a device having an orifice fitted with a suitable seating surface and a means for closing the orifice. A piping system should have as many valves as are needed to assure complete and adequate control of flow. Complete sectionalizing of a system is important from the standpoint of both maintenance and control. Some valves, such as globe valves, are used to throttle the flow through a pipe. Other types of valves, such as gate valves, are normally kept either fully open or fully closed. In larger piping installations, i.e., those utilizing piping of two inches or greater, the inlet and outlet of a valve are flanged. The flanges on the valve are bolted to the flanges on a pipe, usually with a gasket between the flange on the pipe and the flange on the valve.

Pipefitters and other personnel who perform maintenance and repair on the valves of piping systems often encounter serious difficulties, particularly when they have to remove and then reinstall a valve. Most piping systems are designed with some amount of flexibility through the use of compression fittings, expansion joints, slip joints and pipe bends. However, a valve with expanding fittings that would eliminate many of the difficulties in valve installation has not been put forward. There have been numerous improvements relating to valves and valve fittings.

Europe Patent Application Publication No. 326,645, published Aug. 9, 1989, describes a high pressure pipe connection of a hydraulic fitting featuring a sealed but detachable end piece capable of resisting hydraulic pressure up to 420 bars. Europe Patent Application Publication No. 1,029,987, published Aug. 23, 2000, shows a service connection at a public water main supply wherein the valve closure element is a spring-loaded ball pressed against a sealing seat in the valve housing.

World Intellectual Property Organization Patent Application Publication No. WO 90/14536, published Nov. 29, 1990, describes a valve for connection to a pressurized water main having a closure mechanism that is biased towards a position in which it seals with a seat in the inlet port. German Patent Application Publication No. 4,338,663 A, published Jun. 8, 1995, describes a process for exchanging drill fittings on gas pipes or household water mains while maintaining the seals between the pipelines and fittings.

Japan Patent Application Publication No. JP 2-256998 A, published Oct. 17, 1990, discloses a piping repair method for replacing old pipe connections with new pipe connections by fitting an expansion joint pipe having a stopper flange into an opening at the cut part of an old pipe. Japan Patent Application Publication No. JP 3-89091 A, published Apr. 15, 1991, shows a process for the repair and replacement of water main gate valves in underwater installations wherein the connection pipe is removed from a single pipe and valves may be repaired or replaced without performing underwater work.

Japan Patent Application Publication No. 5-196175, published Aug. 6, 1993, describes a joint pipe with metal piece for fitting hydraulic piping that enables one kind of a joint pipe to be adapted to a plurality of types of hydraulic piping. Japanese Patent No. 6-346498, published Dec. 20, 1994, discloses a member for connecting a gate valve that abuts the flange surface of the internal valve of a vacuum type sewage system.

Japan Patent Application Publication No. JP 7-110072 A, published Apr. 25, 1995, shows a gate valve wherein the generation of corrosion and rust can be prevented in the valve body by applying an inner layer of corrosion proof resin. Japan Patent Application Publication No. JP 7-190276 A, published Jul. 28, 1995, describes a connection structure for a gate valve accomplished by connecting a reception port processing piece to an inserting side pressing piece by a connecting member.

Japan Patent Application Publication No. JP 2001-021078 A, published Jan. 1, 2001, shows a hydraulic fitting having an inexpensive general purpose hydraulic pressure sensor integrated in to the fitting. Japan Patent Application Publication No. JP 2004-125090 A, published Apr. 22, 2004, describes an installation and construction method for a butterfly valve wherein the butterfly valve is in constant water.

None of the above inventions and patents, taken either singly or in combination, is seen to describe the instant invention as claimed. Thus, a water valve with expanding fittings solving the aforementioned problems is desired.

### SUMMARY OF THE INVENTION

The present invention is a water valve with expanding fittings. The water valve with expanding fittings is designed to eliminate the cost and labor of fitting a water valve into any type of piping system. The water valve with expanding fittings is very cost efficient, since it enables a valve to be installed without cutting and welding on a piping installation to fit a valve having a fixed distance between flanges into a pipe run. The expanding fittings may be used in combination with any type of water valve known in the art.

The water valve with expanding fittings allows a pipefitter to adjust the distance between flanges on a valve so that a water valve may be installed quickly and efficiently. Instead of having flanges connected to the inlet and outlet pipes of a valve, the valve flanges are connected to a sleeve that slides on the exterior of both the inlet pipe and the outlet pipe. The relative position of the sleeves is controlled by hydraulic pressure. Hydraulic pressure is administered through hydraulic fittings in both the inlet pipe and the outlet pipe.

The water valve with expanding fittings includes a valve body having an inlet pipe and an outlet pipe extending outward from the valve body. The inlet pipe is formed from an annular wall having an outwardly extending lip about an end of the pipe. The wall of the inlet pipe has a passage defined therein extending from adjacent the valve body and has a discharge opening adjacent the lip. The water valve includes a sleeve with an attached pipe flange at a first end and an inwardly extending lip at an opposing second end. The inlet pipe lip is slidably disposed within the sleeve, and the sleeve lip encircles the inlet pipe between the inlet pipe lip and the valve body to prevent separation of the sleeve from the inlet pipe. The sleeve travels along the outward surface of the lip of the inlet pipe, the range of travel of the sleeve being limited by the inwardly extending lip on the sleeve.

A compression spring is disposed between the outwardly extending lip of the inlet pipe and the pipe flange. A hydraulic fitting attached to the exterior of the inlet pipe in fluid communication with the passage, the fitting being adapted for attachment to a hydraulic pump. A seal can be disposed between the sleeve lip and the inlet pipe. A seal can be disposed between the inlet pipe lip and the sleeve. The sleeve, inlet pipe, and/or outlet pipe can include threading.

The outlet pipe is formed from an annular wall having an outwardly extending lip about an end of the outlet pipe. The wall of the outlet pipe has a passage defined therein extending from adjacent the valve and having a discharge opening adjacent the lip. An outlet sleeve has an attached pipe flange at a first end and an inwardly extending lip at an opposing second end. The outlet pipe lip is slidably disposed within the outlet sleeve. The outlet sleeve lip encircles the outlet pipe between the outlet pipe lip and the valve body to prevent separation of the outlet sleeve from the outlet pipe. The outlet sleeve travels along the outward surface of the lip of the outlet pipe, the range of travel of the outlet sleeve being limited by the inwardly extending lip on the outlet sleeve.

A compression spring is disposed between the outwardly extending lip on the outlet pipe and the pipe flange. A hydraulic fitting is attached to the exterior of the outlet pipe in fluid communication with the passage in the outlet pipe wall. The fitting is adapted for attachment to a hydraulic pump. The valve body can be a globe valve, a gate valve, or other type of valve.

These and other features of the present invention will become readily apparent upon further review of the following specification and drawings.

### BRIEF DESCRIPTION OF THE DRAWINGS

FIG. 1 is an environmental, perspective view of an example of a globe valve with expanding fittings according to the present invention.

FIG. 2 is a sectional view of the gate valve with expanding fittings shown in FIG. 1.

FIG. 3 is an environmental, perspective view of another example of a globe valve with expanding fittings according to the present invention.

FIG. 4 is a sectional view of the gate valve with expanding fittings shown in FIG. 3.

Similar reference characters denote corresponding features consistently throughout the attached drawings.

### DETAILED DESCRIPTION OF THE PREFERRED EMBODIMENTS

The present invention is a water valve with expanding fittings. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

The present invention is a water valve with expanding fittings. The expanding fittings may be used in combination with any type of water valve known in the art, and for any type of piping system, e.g., shipping applications, marine applications, building applications, vehicle applications, aviation applications, etc.

The layout of most piping systems is not designed to precise tolerances. After a piping system has been constructed, it often takes pipefitters or mechanics considerable time, effort and cost to place valves in the system. Frequently pipes must be cut, flanges welded in place, or inserts added to install a valve.

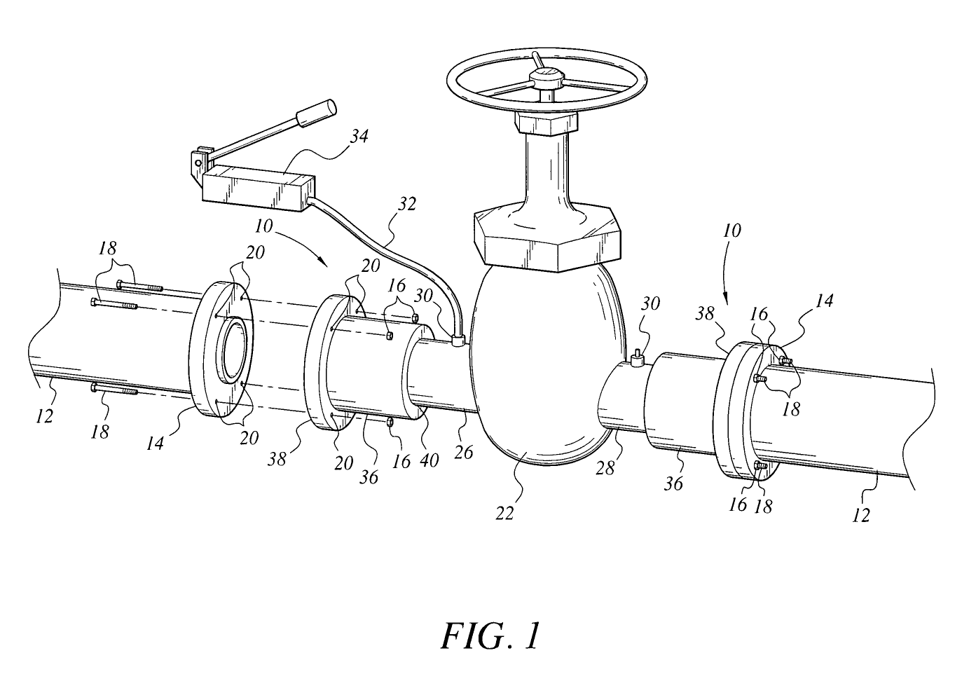

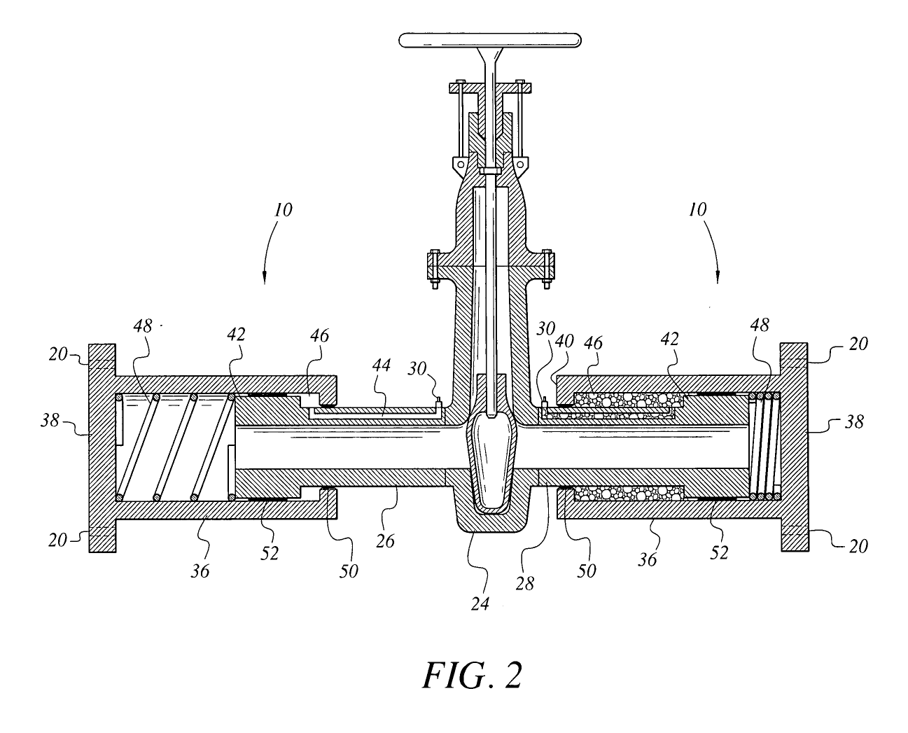

Referring to the drawings, FIGS. 1 and 2 show a water valve with expanding fittings 10 that allows a pipefitter to adjust the distance between flanges on a valve so that a water valve may be installed quickly and efficiently. A globe valve 22 with expanding fittings 10 is being installed in a water main 12 or other pipe run. The globe valve 22 is conventional, except that the inlet pipe 26 and the outlet pipe 28 on the globe valve 22 do not have conventional fixed flanges. Both the inlet pipe 26 and the outlet pipe 28 are connected to the valve 22 by valve flanges 38 connected to a sleeve 36 that slides on the exterior of the respective pipes. The relative position of the sleeves 36 is controlled by hydraulic pressure. Hydraulic pressure is applied through hydraulic fittings 30 in both the inlet pipe 26 and the outlet pipe 28. Hydraulic fluid can be added to the hydraulic fitting 30 on the inlet pipe 26 through a hydraulic line 32 attached to a hydraulic hand pump 34.

The valve flange 38 is bolted to the flange 14 on the water main 12 using nuts 16 and bolts 18 inserted through the aligned holes 20 in the water main flange 14 and the valve flange 38. The pipefitter or mechanic then uses the hydraulic hand pump 34 to adjust the sleeve 36 over the inlet pipe 26 so that the valve flange 38 meets the opposite water main flange 14. A user may reverse the order of installing the water valve 10 to suit the particular piping system. It is also contemplated that the water valve with expanding fittings 10 may be equipped with expanded fittings 10 either only on the inlet pipe 26 or only on the outlet pipe 28, in which case the other pipe can have a conventional fixed flange fitting.

The internal configuration of the water valve with expanding fitting 10 is shown in FIG. 2. Both the inlet pipe 26 and the outlet pipe 28 feature hydraulic fittings 30 that lead to a hydraulic fluid passage 44 within the wall of the pipe. The hydraulic fluid passage 44 leads to a void space 46 or cavity having a cylindrical cross section. The void space 46 is a space formed by the exterior of the inlet pipe 26 (or outlet pipe 28), the interior of the sleeve 36, the inward wall of the sleeve lip 40, and the inward wall of the pipe lip 42. Additional components of the expanded fitting 10 include a coil spring 48, a sleeve lip seal 50 and a pipe lip seal 52. The coil spring 48 is placed between the outward wall of the pipe lip 42 and the inward wall of the valve flange 38. The sleeve lip seal 50 is attached to the inner face of the sleeve lip 40. The pipe lip seal 52 encircles pipe lip 42.

The inlet pipe 26 shows a sleeve 36 that is fully extended. When no hydraulic fluid is added to the void space 46, the coil spring 48 fully expands to push the sleeve 36 and valve flange 38 outward. In the event of failure of the hydraulic fitting 30 or either the sleeve lip seal 50 or the pipe lip seal 52, so that hydraulic pressure is lost, the expanded fitting 10 is in the fully extended position as a safety feature.

The outlet pipe 28 has a sleeve 36 that is fully retracted. When a user of the water valve 10 pumps hydraulic fluid into the void space 46 through the hydraulic fluid passage 44 the hydraulic fluid acts against the sleeve lip 40 and pushes the sleeve 36 back, thereby compressing coil spring 48. (Although fluid is shown only above the outlet pipe 28 in the drawing, it will be understood that the void space 46 may be annular so that fluid will press against lip 40 throughout its circumference). In this manner, the operation of the expanding fitting 10 is similar to a piston. Hydraulic fluid is prevented from escaping the void space by the sleeve lip seal 50 and the pipe lip seal 52. The sleeve lip seal 50 and the pipe lip seal 52 are made of carbon, self lubricating plastic, self lubricating rubber, or other suitable sealing material.

The water valve with expanding fittings 10 may come in a variety of sizes. For exemplary purposes only, the valve flanges 38 may be dimensioned and configured to be attached to the pipe flanges associated with two, four, six, eight, ten inch pipe as well as metric and non-standard pipe sizes. As previously described, the expanding fittings may be used in combination with any type of water valve known in the art, and for any type of piping system, e.g., shipping applications, marine applications, building applications, vehicle applications, aviation applications, etc.

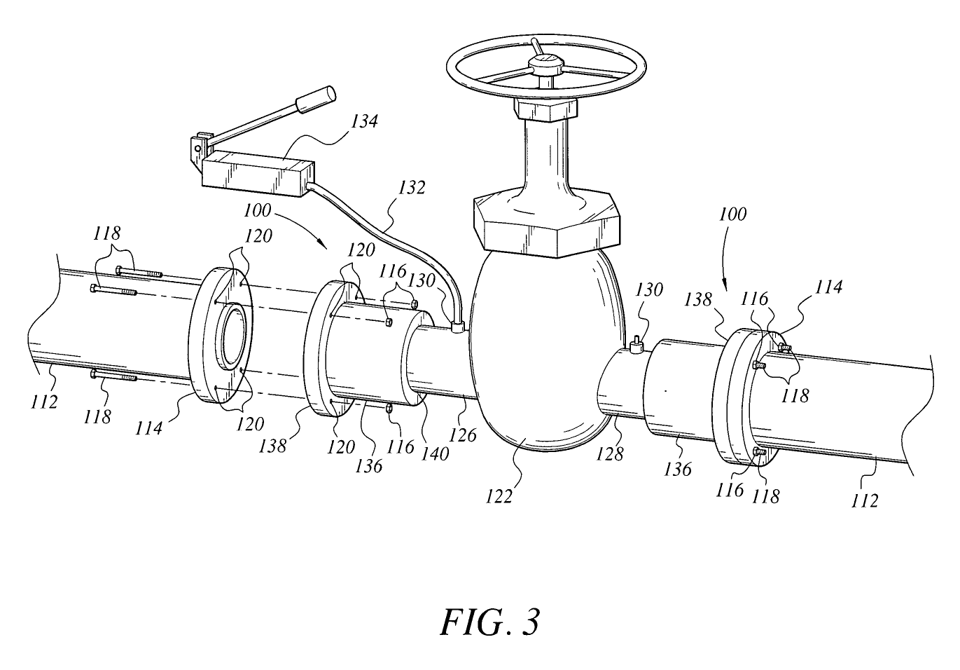

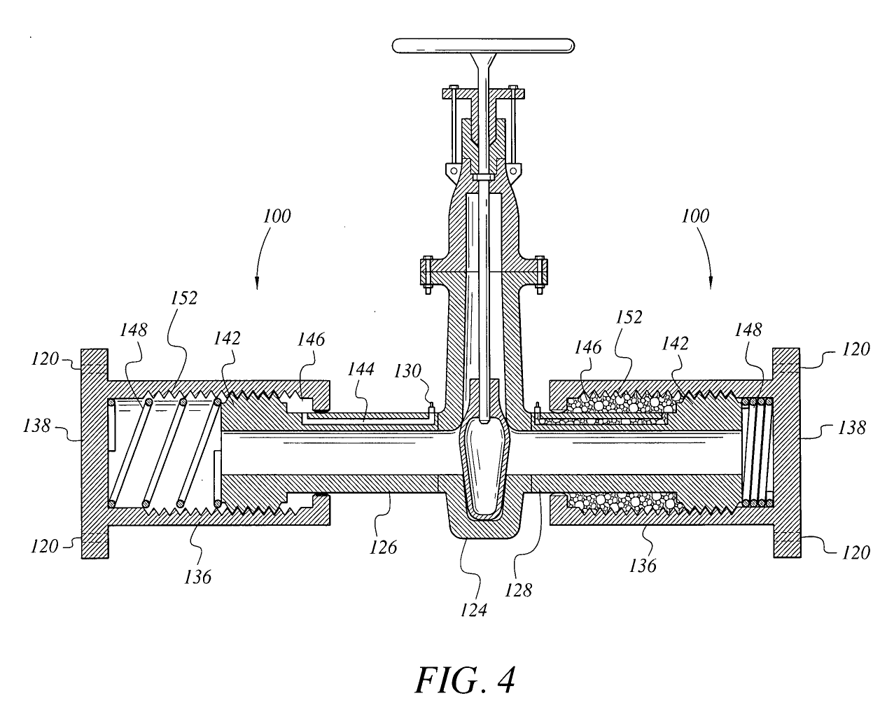

FIGS. 3 and 4 show another example of a water valve with expanding fittings 100 that allows a pipefitter to adjust the distance between flanges on a valve so that a water valve may be installed quickly and efficiently. A globe valve 122 with expanding fittings 100 is being installed in a water main 112 or other pipe run. The globe valve 122 is conventional, except that the inlet pipe 126 and the outlet pipe 128 on the globe valve 122 do not have conventional fixed flanges. Both the inlet pipe 126 and the outlet pipe 128 are connected to the valve 122 by valve flanges 138 connected to a sleeve 136 that slides on the exterior of the respective pipes. The relative position of the sleeves 136 is controlled by hydraulic pressure. Hydraulic pressure is applied through hydraulic fittings 130 in both the inlet pipe 126 and the outlet pipe 128. Hydraulic fluid can be added to the hydraulic fitting 130 on the inlet pipe 126 through a hydraulic line 132 attached to a hydraulic hand pump 134.

The valve flange 138 is bolted to the flange 114 on the water main 112 using nuts 116 and bolts 118 inserted through the aligned holes 120 in the water main flange 114 and the valve flange 138. The pipefitter or mechanic then uses the hydraulic hand pump 134 to adjust the sleeve 136 over the inlet pipe 126 so that the valve flange 138 meets the opposite water main flange 114. A user may reverse the order of installing the water valve with expanding fittings 100 to suit the particular piping system. It is also contemplated that the water valve with expanding fittings 100 may be equipped with expanding fittings 100 either only on the inlet pipe 126 or only on the outlet pipe 128, in which case the other pipe can have a conventional fixed flange fitting.

The internal configuration of the water valve with expanding fitting 100 is shown in FIG. 4. Both the inlet pipe 126 and the outlet pipe 128 feature hydraulic fittings 130 that lead to a hydraulic fluid passage 144 within the wall of the pipe. The hydraulic fluid passage 144 leads to a void space 146 or cavity having a cylindrical cross section. The void space 146 is a space formed by the exterior of the inlet pipe 126 (or outlet pipe 128), the threaded interior of the sleeve 136, the inward wall of the sleeve lip, and the inward wall of the pipe lip 142. Additional components of the expanding fittings 100 include a coil spring 148, and sleeve threads 152. The coil spring 148 is placed between the outward wall of the pipe lip 142 and the inward wall of the valve flange 138. The sleeve threads 152 engage with the threads on the outward end of the pipe.

The inlet pipe 126 shows a sleeve 136 that is fully extended. When no hydraulic fluid is added to the void space 146, the coil spring 148 fully expands to push the sleeve 136 and valve flange 138 outward. In the event of failure of the hydraulic fitting 130, so that hydraulic pressure is lost, the valve with expanding fittings 100 is in the fully extended position as a safety feature.

The outlet pipe 128 has a sleeve 136 that is fully retracted. When a user of the water valve 100 pumps hydraulic fluid into the void space 146 through the hydraulic fluid passage 144 the hydraulic fluid acts against the sleeve lip 140 and pushes the sleeve 136 back, thereby compressing coil spring 148. (Although fluid is shown only above the outlet pipe 128 in the drawing, it will be understood that the void space 146 may be annular so that fluid will press against lip 140 throughout its circumference). In this manner, the operation of the valve with expanding fittings 100 is similar to a piston. Hydraulic fluid is prevented from escaping the void space by the sleeve threads 152 and the outer threads on the end of the pipe. The threadings can be formed of carbon, self lubricating plastic, self lubricating rubber, or other suitable sealing material.

The water valve with expanding fittings 100 may come in a variety of sizes. For exemplary purposes only, the valve flanges 138 may be dimensioned and configured to be attached to the pipe flanges associated with two, four, six, eight, ten inch pipe as well as metric and non-standard pipe sizes. As previously described, the expanding fittings may be used in combination with any type of water valve known in the art, and for any type of piping system, e.g., shipping applications, marine applications, building applications, vehicle applications, aviation applications, etc.

In summary, the water valve with expanding fittings includes a valve body having an inlet pipe and an outlet pipe extending outward from the valve body. The inlet pipe is formed from an annular wall having an outwardly extending lip about an end of the pipe. The wall of the inlet pipe has a passage defined therein extending from adjacent the valve body and has a discharge opening adjacent the lip. The water valve includes a sleeve with an attached pipe flange at a first end and an inwardly extending lip at an opposing second end. The inlet pipe lip is slidably disposed within the sleeve, and the sleeve lip encircles the inlet pipe between the inlet pipe lip and the valve body to prevent separation of the sleeve from the inlet pipe. The sleeve travels along the outward surface of the lip of the inlet pipe, the range of travel of the sleeve being limited by the inwardly extending lip on the sleeve.

A compression spring is disposed between the outwardly extending lip of the inlet pipe and the pipe flange. A hydraulic fitting attached to the exterior of the inlet pipe in fluid communication with the passage, the fitting being adapted for attachment to a hydraulic pump. A seal can be disposed between the sleeve lip and the inlet pipe. A seal can be disposed between the inlet pipe lip and the sleeve. The sleeve, inlet pipe, and/or outlet pipe can include threading.

The outlet pipe is formed from an annular wall having an outwardly extending lip about an end of the outlet pipe. The wall of the outlet pipe has a passage defined therein extending from adjacent the valve and having a discharge opening adjacent the lip. An outlet sleeve has an attached pipe flange at a first end and an inwardly extending lip at an opposing second end. The outlet pipe lip is slidably disposed within the outlet sleeve. The outlet sleeve lip encircles the outlet pipe between the outlet pipe lip and the valve body to prevent separation of the outlet sleeve from the outlet pipe. The outlet sleeve travels along the outward surface of the lip of the outlet pipe, the range of travel of the outlet sleeve being limited by the inwardly extending lip on the outlet sleeve.

A compression spring is disposed between the outwardly extending lip on the outlet pipe and the pipe flange. A hydraulic fitting is attached to the exterior of the outlet pipe in fluid communication with the passage in the outlet pipe wall. The fitting is adapted for attachment to a hydraulic pump. The valve body can be a globe valve, a gate valve, or other type of valve.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. A water valve with expanding fittings for adjusting the distance between flanges on a water valve, the water valve comprising:
a valve body having an inlet pipe and an outlet pipe extending outward from the valve body, the inlet pipe being formed from an annular wall having an outwardly extending lip about an end of the pipe, the wall of the inlet pipe having a passage defined therein extending from adjacent the valve body and having a discharge opening adjacent the lip; and
a sleeve having an attached pipe flange at a first end and an inwardly extending lip at an opposing second end, the inlet pipe lip being slidably disposed within the sleeve, the sleeve lip encircling the inlet pipe between the inlet pipe lip and the valve body to prevent separation of the sleeve from the inlet pipe,
whereby the sleeve travels along the outward surface of the lip of the inlet pipe, the range of travel of the sleeve being limited by the inwardly extending lip on the sleeve.

2. The water valve with expanding fittings according to claim 1, further comprising a compression spring disposed between the outwardly extending lip of the inlet pipe and the pipe flange.

3. The water valve with expanding fittings according to claim 1, further comprising a hydraulic fitting attached to the exterior of the inlet pipe in fluid communication with the passage, the fitting being adapted for attachment to a hydraulic pump.

4. The water valve with expanding fittings according to claim 1, further comprising a seal disposed between the sleeve lip and the inlet pipe.

5. The water valve with expanding fittings according to claim 1, further comprising a seal disposed between the inlet pipe lip and the sleeve.

6. The water valve with expanding fittings according to claim 1, wherein the inlet pipe includes threading.

7. The water valve with expanding fittings according to claim 1, wherein the outlet pipe includes threading.

8. The water valve with expanding fittings according to claim 1, wherein the sleeve has threading.

9. The water valve with expanding fittings according to claim 1, wherein said outlet pipe is formed from an annular wall having an outwardly extending lip about an end of the outlet pipe, the wall of the outlet pipe having a passage defined therein extending from adjacent the valve and having a discharge opening adjacent the lip, said water valve further comprising an outlet sleeve having an attached pipe flange at a first end and an inwardly extending lip at an opposing second end, the outlet pipe lip being slidably disposed within the outlet sleeve, the outlet sleeve lip encircling the outlet pipe between the outlet pipe lip and the valve body to prevent separation of the outlet sleeve from the outlet pipe,
whereby the outlet sleeve travels along the outward surface of the lip of the outlet pipe, the range of travel of the outlet sleeve being limited by the inwardly extending lip on the outlet sleeve.

10. The water valve with expanding fittings according to claim 9, further comprising a compression spring disposed between the outwardly extending lip on the outlet pipe and the pipe flange.

11. The water valve with expanding fittings according to claim 9, further comprising a hydraulic fitting attached to the exterior of the outlet pipe in fluid communication with the passage in the outlet pipe wall, the fitting being adapted for attachment to a hydraulic pump.

12. The water valve with expanding fittings according to claim 9, further comprising a seal disposed between the outlet sleeve lip and the outlet pipe.

13. The water valve with expanding fittings according to claim 9, further comprising a seal disposed between the outlet pipe lip and the outlet sleeve.

14. The water valve with expanding fittings according to claim 9, wherein the inlet pipe includes threading.

15. The water valve with expanding fittings according to claim 9, wherein the outlet pipe includes threading.

16. The water valve with expanding fittings according to claim 1, wherein the valve body is a globe valve.

17. The water valve with expanding fittings according to claim 1, wherein the valve body is a gate valve.
